(19) United States
(12) Patent Application Publication
(10) Pub. No.: US 2013/0050415 A1
(43) Pub. Date: Feb. 28, 2013

(54) System and Method of Handling Data Frames for Stereoscopic Display

(71) Applicant: Tzung-Ren WANG, Tainan City (TW)

(72) Inventor: Tzung-Ren WANG, Tainan City (TW)

(73) Assignee: HIMAX TECHNOLOGIES LIMITED, Tainan City (TW)

(21) Appl. No.: 13/220,863

(22) Filed: Aug. 30, 2011

(51) Int. Cl. H04N 13/00; H04N 13/04

(52) U.S. Cl. 348/43; 348/51; 348/E13.064

(57) ABSTRACT

In one embodiment, a method of handling a data frame in a video transmitter device comprises receiving a two-dimensional image frame having a first number of lines and a first number of column, receiving a depth map associated with the two-dimensional image frame, the depth map having a second number of lines and a second number of columns, scaling down the two-dimensional image frame and the depth map to obtain a second two-dimensional image frame and a second depth map of smaller sizes, assembling the second two-dimensional image frame with the second depth map into a data frame, and transmitting the data frame from a video transmitter device to a video receiver device. In other embodiments, video transmitter and receiver devices are also described.

### BACKGROUND

1. Field of the Invention

The present invention relates to systems and methods of handling data frames for stereoscopic display.

2. Description of the Related Art

Various frame formats are currently proposed for stereoscopic displays. One format is the frame-compatible format in which each stereoscopic pair of left-view and right-view images are encapsulated into one frame side-by-side or on top of each other. Another format is the depth-image-based representation format (also called “2D plus depth” format) in which a two-dimensional (2D) image frame and an associated depth map are provided. Virtual image frames can be constructed from the 2D image frame and the depth map to form multiple stereoscopic views for display.

In the 2D plus depth format, the 2D image frame can typically comprise red, green and blue color data (each color is coded as 8-bit data per pixel), and the associated depth map can include depth information coded as 8-bit grayscale data per pixel. When it is transmitted through a high-definition interface (e.g., the High-Definition Multimedia Interface), this format usually results in the receiver device to store the 2D image frame and the depth map in two separate frame buffers of a same size. Because the content of the depth map is less than that of the 2D image frame, the space of the frame buffer in which the depth data are stored is not efficiently used.

Therefore, there is a need for an improved system that can handle and transmit the 2D plus depth format in a more efficient way.

### SUMMARY

The present application describes systems and methods of handling data frames for stereoscopic display. In one embodiment, a method of handling a data frame in a video transmitter device is described. The method comprises receiving a two-dimensional image frame having a first number of lines and a first number of column, receiving a depth map associated with the two-dimensional image frame, the depth map having a second number of lines and a second number of columns, scaling down the two-dimensional image frame and the depth map to obtain a second two-dimensional image frame and a second depth map of smaller sizes, assembling the second two-dimensional image frame with the second depth map into a data frame, and transmitting the data frame from a video transmitter device to a video receiver device.

In other embodiments, video transmitter devices are described. A transmitter device can comprise a computer-readable medium containing a plurality of data frames, and an output controller adapted to access the computer-readable medium and output the data frames, wherein each of the data frames includes image data of a two-dimensional image frame and depth data of a depth map, the image data being down scaled in size compared to a corresponding image frame presented on a display screen.

In yet other embodiments, a video receiver device is provided. The video receiver device can comprise a frame buffer, and a stereoscopic rendering unit coupled with the frame buffer. The receiver device is configured to receive and store a data frame from a video transmitter device, the data frame including pixel color data of a two-dimensional image frame and depth data of a depth map, retrieve the two-dimensional image frame and the depth map from the data frame stored in the frame buffer, upscale the two-dimensional image frame and the depth map, and construct a virtual two-dimensional image frame based on the up-scaled two-dimensional image frame and depth map.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIG. 1 is a simplified diagram illustrating a configuration for transmitting video content from a video transmitter device to a video receiver device;

FIG. 2 is a schematic timing diagram illustrating one embodiment of the data frame F formed according to a first format;

FIG. 3 is a signal timing diagram for transmitting a data frame;

FIG. 4 is a schematic diagram illustrating one embodiment of a formatter unit used in the transmitter device;

FIG. 5 is a schematic diagram illustrating the content of a data frame assembled according to the first format;

FIG. 6 is a flowchart of exemplary method steps performed in the transmitter device for forming a data frame;

FIG. 7 is a flowchart of exemplary method steps for handling the data frame formed according to the first format in the receiver device;

FIG. 8 is a schematic diagram illustrating a data frame formed according to a second format;

FIG. 9 is a schematic diagram illustrating another embodiment of a formatter unit that can be implemented in the transmitter device for forming a data frame according to the second format;

FIG. 10 is a schematic diagram illustrating the content of the data frame assembled according to the second format;

FIG. 11 is a flowchart of exemplary method steps performed in the transmitter device for forming a data frame according to the second format;

FIG. 12 is a flowchart of exemplary method steps for handling the data frame formed according to the second format in the receiver device;

FIG. 13 is a schematic diagram illustrating a data frame formed according to a third format;

FIG. 14 is a schematic diagram illustrating a data frame formed according to fourth format; and

FIG. 15 is a schematic diagram illustrating another system embodiment for transmitting video content from a video transmitter device to a video receiver device.

### DETAILED DESCRIPTION OF EMBODIMENTS

The present application describes systems and methods of handling data frames for stereoscopic display. More particularly, the embodiments described herein provide various frame formats that are based on the 2D plus depth format, i.e., using one 2D image frame containing pixel color data, and one associated depth map containing depth data. However, it is understood that the frame formats described herein can be applicable for any variant representations that have other types of depth-rendering related data in the depth map, such as disparity data, depth and occlusion/transparency information, etc. Accordingly, the term “depth map” can be construed to include depth data as well as any other types of depth-rendering related data that may be applied on a 2D image frame to construct one or more virtual stereoscopic image frame.

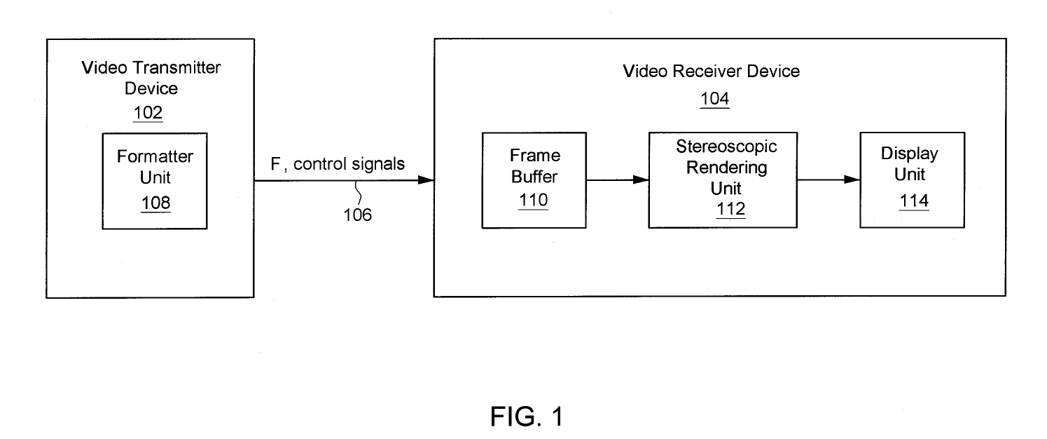

FIG. 1 is a simplified diagram illustrating a configuration for transmitting video content from a video transmitter device 102 to a video receiver device 104. The transmitter device 102 can operate to transmit a stream of data, and various control signals through a link interface 106 to the receiver device 104. In one embodiment, the link interface 106 can be a HDMI link. However, possible embodiments may also include other transfer interfaces including, without limitation, Digital Visual Interface (DVI), DisplayPort, etc. In one embodiment, the data transmitted through the link interface 106 can include a plurality of data frames F comprising a two-dimensional (2D) image frame M, and a depth map Z associated with the 2D image frame M. The 2D image frame M can include pixel color data for representing a scene. The depth map Z can include depth information per pixel of the image represented by the 2D image frame M. The transmitter device 102 can include a formatter unit 108 adapted to assemble the image frame M and the depth map Z into the data frame F according to a predetermined format, and then transmit the data frame F through the link interface 106. The control signals transmitted to the receiver device 104 can include vertical and horizontal synchronizations signals, data enable signals, and the like.

The receiver device 104 can include a frame buffer 110 into which the received data frame F is stored, a stereoscopic rendering unit 112, and a display unit 114. The stereoscopic rendering unit 112 can retrieve the 2D image frame M and depth map Z from the data frame F, apply computation to upscale the 2D image frame M and depth map Z, and construct one or more virtual 2D image frame M₁ based on the image frame M and the depth map Z. The up-scaled image frame M and virtual image frame M₁ can form a stereoscopic pair that can be displayed via the display unit 114. Examples of the display unit 114 can include, without limitation, a liquid crystal display panel (LCD), an electroluminescent display panel, and the like.

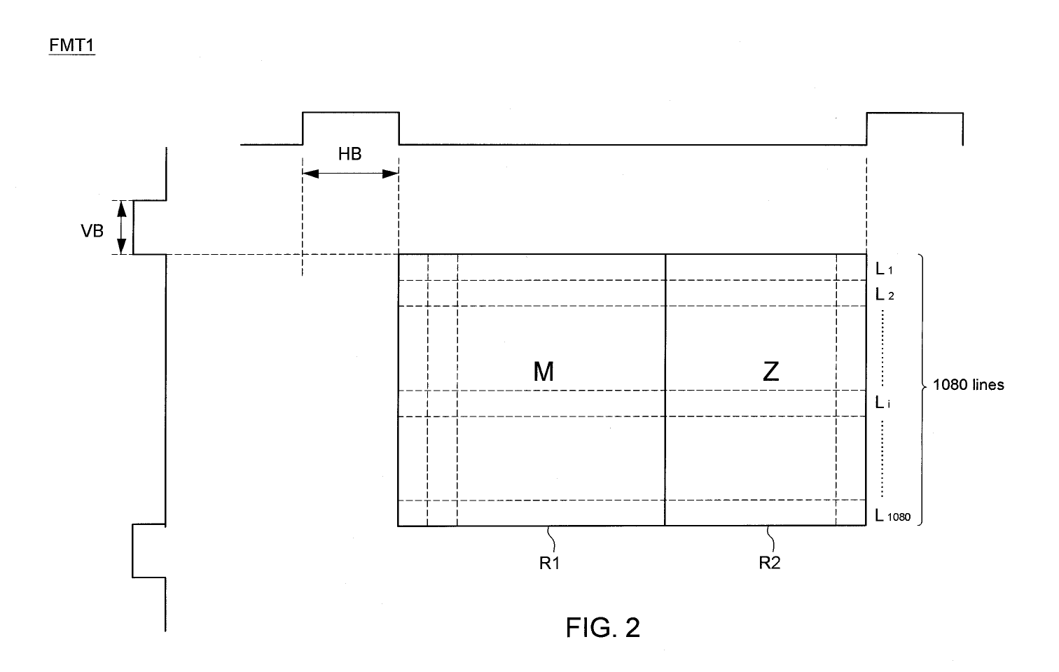

FIG. 2 is a schematic timing diagram illustrating one embodiment of the data frame F formed according to a format FMT1. According to the format FMT1, the data frame F can include a first region R1 where is placed the content of the 2D image frame M (e.g., including red, green and blue pixel data), and a second region R2 horizontally adjacent to the first region R1 where is placed the content of the depth map Z. The data frame F formed by the first and second regions R1 and R2 can include a plurality of lines (L₁, . . . , L₁₀₈₀), each line Lᵢ including pixel color data and depth information.

As shown in FIG. 2, the data format FMT1 can also include a horizontal blanking interval HB inserted between each line Lᵢ, and a vertical blanking interval VB inserted between the last line of a previous data frame and a first line of a next data frame.

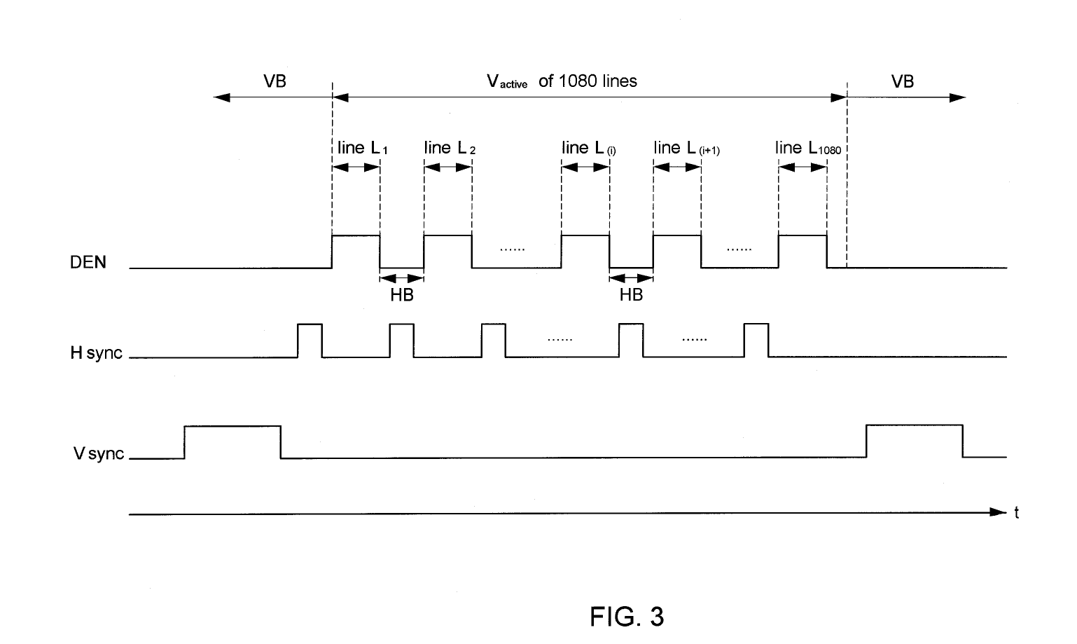

In conjunction with FIG. 2, FIG. 3 is a signal timing diagram for transmitting the data frame F. In the illustrated embodiment, the data frame F can exemplary include 1080 lines. A pulse of a vertical synchronization signal VSYNC can be used to define the vertical blanking interval VB inserted before each data frame F to be transmitted. One pulse of the vertical synchronization signal VSYNC can be followed with a video active period V_{active} of 1080 lines that form the data frame F. In the video active period V_{active}, a high level of a data enable signal DEN can indicate when pixel data of red (R), green (G) and blue (B) colors or depth data are present for each line. A pulse of a horizontal synchronization signal HSYNC can be used to define the horizontal blanking interval HB between a previous line Lᵢ and a next line Lᵢ₊₁. The end of one frame F can be indicated by another pulse of the vertical synchronization signal VSYNC.

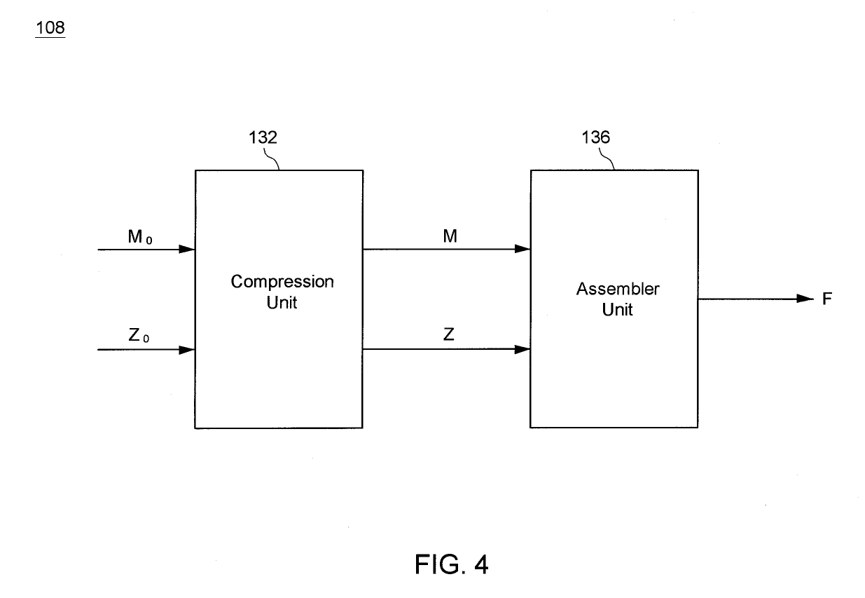

FIG. 4 is a schematic diagram illustrating one embodiment of the formatter unit 108. The formatter unit 108 can include a compression unit 132 and an assembler unit 136. The formatter unit 108 can receive an initial 2D image frame M₀ and an initial depth map Z₀. In one embodiment, the 2D image frame M₀ can exemplary have a size of 1920*3 columns (i.e., the factor 3 indicates the three sub-pixels of red, green and blue color for each pixel) by 1080 lines, and the depth map Z₀ can have a size of 1920 columns by 1080 lines. The compression unit 132 can receive the 2D image frame M₀ and the depth map Z₀, scale down the 2D image frame M₀ to obtain the 2D image frame M of a smaller size, and scale down the depth map Z₀ to obtain a second depth map Z of a smaller size associated with the down scaled 2D image frame M. In one embodiment, the compression unit 132 can downsize the horizontal dimension of the initial image frame M₀ and depth map Z₀ by 25%, such that the size of the 2D image frame M can be equal to 1440*3 columns by 1080 lines, and the size of the depth map Z can be equal to 1440 columns by 1080 lines. However, other downscale ratios may be applicable. In particular, the applied downscale ratio can be such that the size of the data frame F formed by the assembly of the 2D image frame M with the depth map Z is substantially equal to the size of the initial image frame M₀. In one embodiment, the assembler unit 136 can assemble each line (i) from the depth map Z after the end of the corresponding line (i) in the 2D image frame M to generate each line (i) of the data frame F.

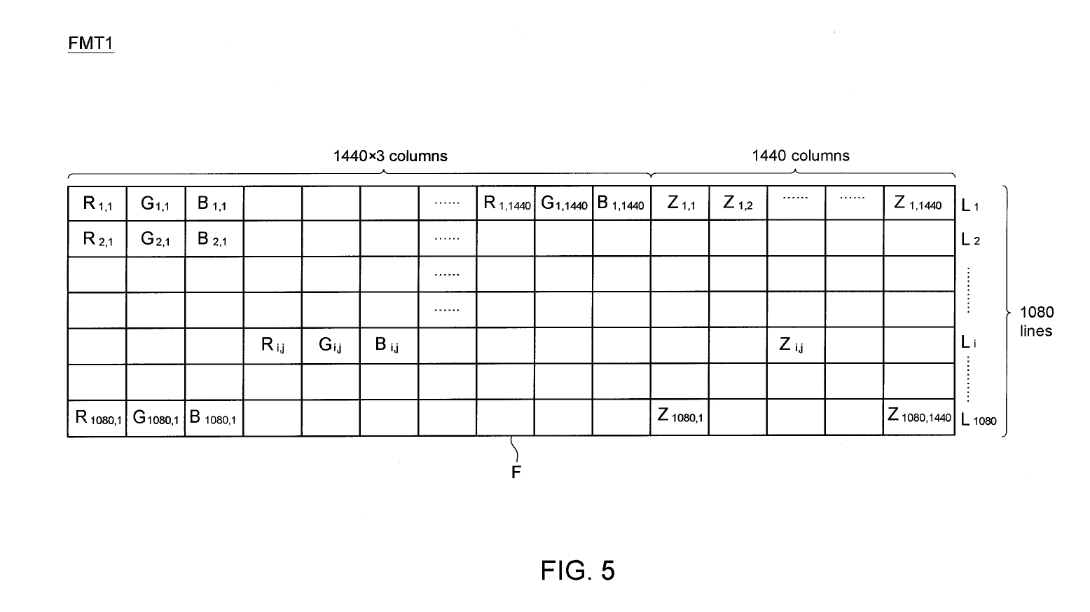

FIG. 5 is a schematic diagram illustrating the content of the data frame F assembled according to the format FMT1. In the portion of the 2D image frame M, R_{i,j}, G_{i,j} and B_{i,j} respectively represent the red, green and blue color data associated with each pixel (i,j), wherein each color data can be exemplary coded with 8 bits, the pixel line index i is in the range [1, 1080], and the pixel column index j is in the range [1, 1440]. In the portion of the depth map Z, Z_{i,j} represents the depth data associated with each pixel (i,j), wherein the depth data Z_{i,j} can be exemplary coded as a 8-bit grayscale value, the pixel line index i is in the range [1, 1080], and the pixel column index j is in the range [1, 1440]. The format FMT1 can accordingly encapsulate color data and depth data contiguously side-by-side in the data frame F that at least has a number of lines equal to that of the initial 2D image frame M₀.

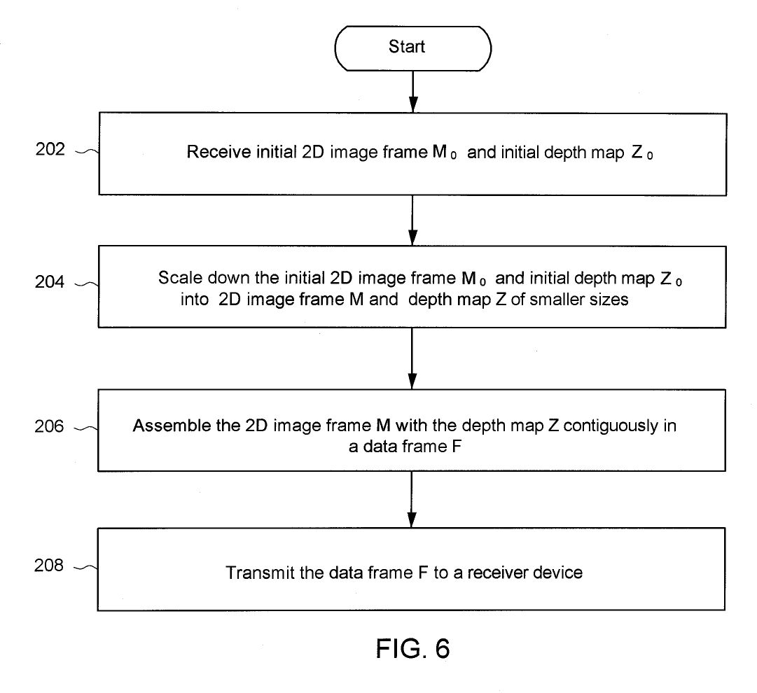

In conjunction with FIGS. 2 through 5, FIG. 6 is a flowchart of exemplary method steps performed in the transmitter device 102 for forming a data frame F according to the format FMT1. In step 202, the formatter unit 108 can receive an initial 2D image frame M₀, and an initial depth map Z₀. In step 204, the compression unit 132 can scale down the initial image frame M₀ and the depth map M₀ respectively into a 2D image frame M and a depth map Z of smaller sizes. For example, suppose that the initial image frame M₀ has a size of 1920*3 columns by 1080 lines, and the initial depth map Z₀ has a size of 1920 columns by 1080 lines. The compression unit 132 can reduce the horizontal dimension of the initial image frame M₀ by 25% to obtain the image frame M of a size equal to 1440*3 columns by 1080 lines, and reduce the horizontal size of the initial depth map Z₀ to obtain the depth map Z of a size equal to 1440 columns by 1080 lines. In step 206, the assembler unit 136 can construct the data frame F according to the format FMT1 by assembling the 2D image frame M contiguously with the depth map Z. In one embodiment, the 2D image frame M can be assembled with the depth map Z contiguously side-by-side, i.e., each line (i) of the depth map Z can be placed immediately after one corresponding line (i) of the image frame M to form one line Lᵢ of the data frame F. Accordingly, the data frame F can have a number of lines equal to the number of lines in the initial image frame M₀, and a number of columns equal to the sum of the columns in the 2D image frame M with the number of columns in the depth map Z. In step 208, the data frame F then can be transmitted from the transmitter device 102 to the receiver device 104 via the link interface 106. As shown in FIG. 3, the data frame F can be transmitted between two successive pulses of the vertical synchronization signals VSYNC.

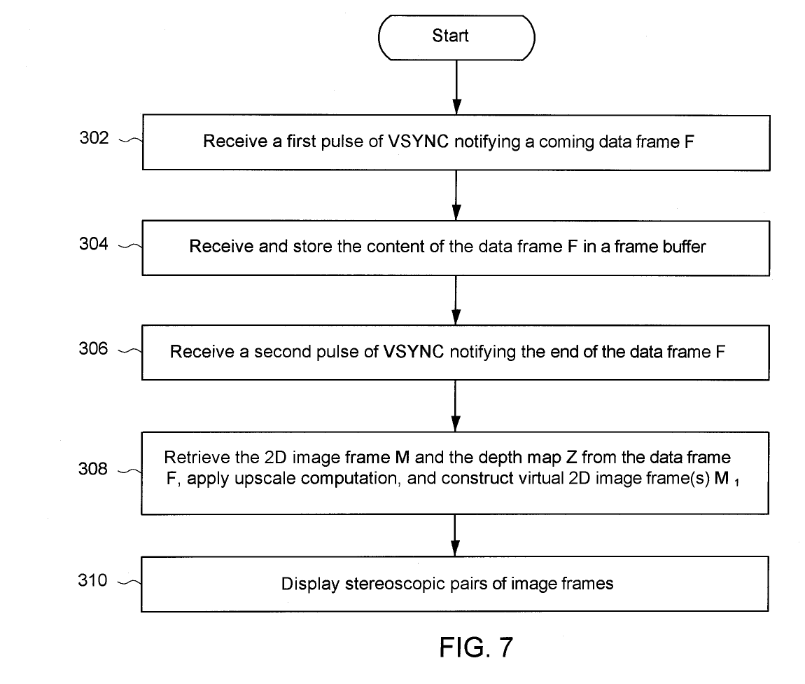

FIG. 7 is a flowchart of exemplary method steps for handling the data frame F formed according to the format FMT1 in the receiver device 104. In step 302, the receiver device 104 can be notified of a next data frame F coming from the transmitter device 102. As shown in FIG. 3, a first pulse of the vertical synchronization signal VSYNC can be transmitted to the receiver device 104 to indicate the coming data frame F. In step 304, the receiver device 104 can receive and store the content of the data frame F in the frame buffer 110. In one embodiment, the receiver device 104 can receive the data frame F line-by-line in a sequential manner, and store each successive line into the frame buffer 110. As illustrated in FIG. 3, the end of a previous line Lᵢ and the start of a next line Lᵢ₊₁ in the data frame F can be detected via a high level of the horizontal synchronization signal HSYNC. In step 306, the receiver device 104 can be notified that all the content of the data frame F have been received by a second pulse of the vertical synchronization signal VSYNC. An example of the data frame F thereby stored in the frame buffer 110 can be as shown in FIG. 5. In step 308, the stereoscopic rendering unit 112 can retrieve the 2D image frame M and the depth map Z from the data frame F, apply upscale computation on the 2D image frame M and the depth map Z, and construct one or more virtual second 2D image frame M₁ via depth-image-based rendering (DIBR) techniques using the 2D image frame M and the depth map Z. In step 310, the up-scaled 2D image frame M (for example left image frame) and the virtual 2D image frame M₁ (for example right image frame) can be used as a stereoscopic pair for display via the display unit 114.

With the format FMT1, the data frame F containing one 2D image frame M and one associated depth map Z can be received between two successive pulses of the vertical synchronization signal VSYNC, and efficiently stored in one single frame buffer. While the aforementioned embodiment illustrates one format in which the 2D image frame M and the depth map Z are assembled contiguously side-by-side, other data formats may also assemble the 2D image frame and the depth map contiguously on top of each other as described hereafter.

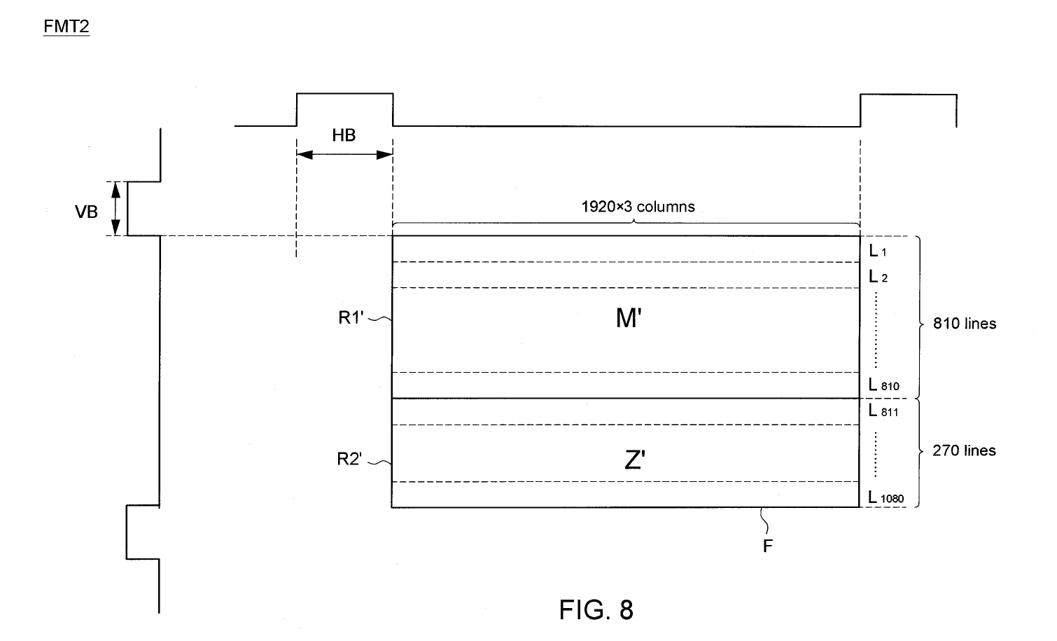

FIG. 8 is a schematic diagram illustrating the data frame F formed according to another format FMT2. According to the format FMT2, the data frame F can include a first region R1′ where is placed a 2D image frame M′ (e.g., including red, green and blue pixel data), and a second region R2′ located adjacent to the bottom of the first region 402 where is placed the content of a depth map Z′. The data frame F formed by the first and second regions R1′ and R2′ can include a plurality of lines (L₁, . . . , L₁₀₈₀), the lines L₁ to L₈₁₀ including pixel color data of the 2D image frame M′, and the lines L₈₁₁ to L₁₀₈₀ including depth information of the depth map Z′ represented as grayscale data.

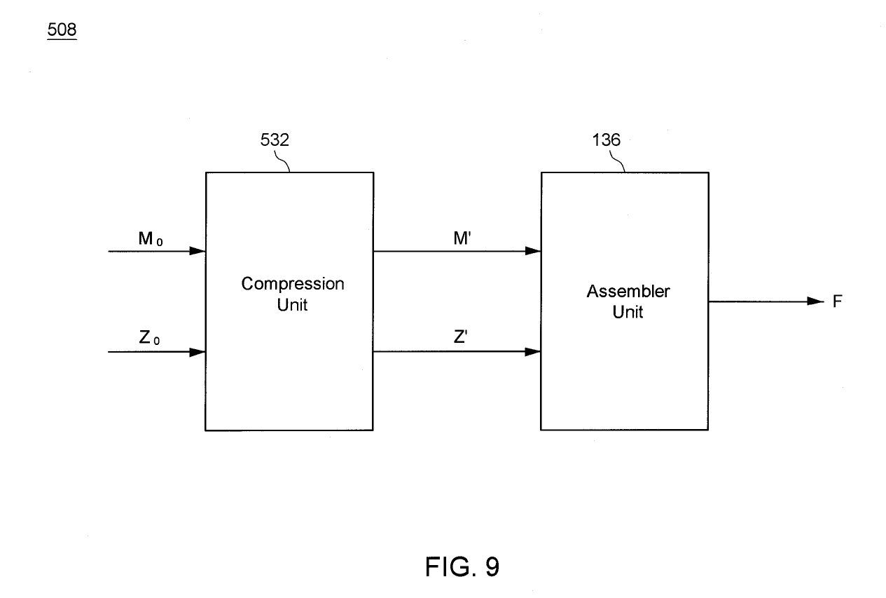

FIG. 9 is a schematic diagram illustrating another formatter unit 508 that can be implemented in the transmitter device 102 for forming a data frame F according to the format FMT2. The formatter unit 508 can include a compression unit 532 and an assembler unit 536. The formatter unit 508 can receive an initial 2D image frame M₀ and an initial depth map Z₀. In one embodiment, the 2D image frame M₀ can exemplary have a size of 1920*3 columns (i.e., the factor 3 indicates the three sub-pixels of red, green and blue color for each pixel) by 1080 lines, and the associated depth map Z₀ can have a size of 1920 columns by 1080 lines. The compression unit 532 can scale down the 2D image frame M₀ to obtain the 2D image frame M′ of a smaller size, and scale down the depth map Z₀ to obtain the depth map Z′ of a smaller size. In one embodiment, the compression unit 532 can downsize the vertical dimension of the image frame M₀ and depth map Z₀ by 25%, such that the size of the 2D image frame M′ can be equal to 1920*3 columns by 810 lines, and the size of the depth map Z′ can be equal to 1920 columns by 810 lines. However, other vertical downscale ratios may be applicable. In particular, the vertical downscale ratio can be such that the size of the data frame F formed by the assembly of the image frame M′ with the depth map Z′ is substantially equal to the size of the initial image frame M₀. The assembler unit 536 can assemble the 2D image frame M′ with the content of the depth map Z′ contiguously on top of each other.

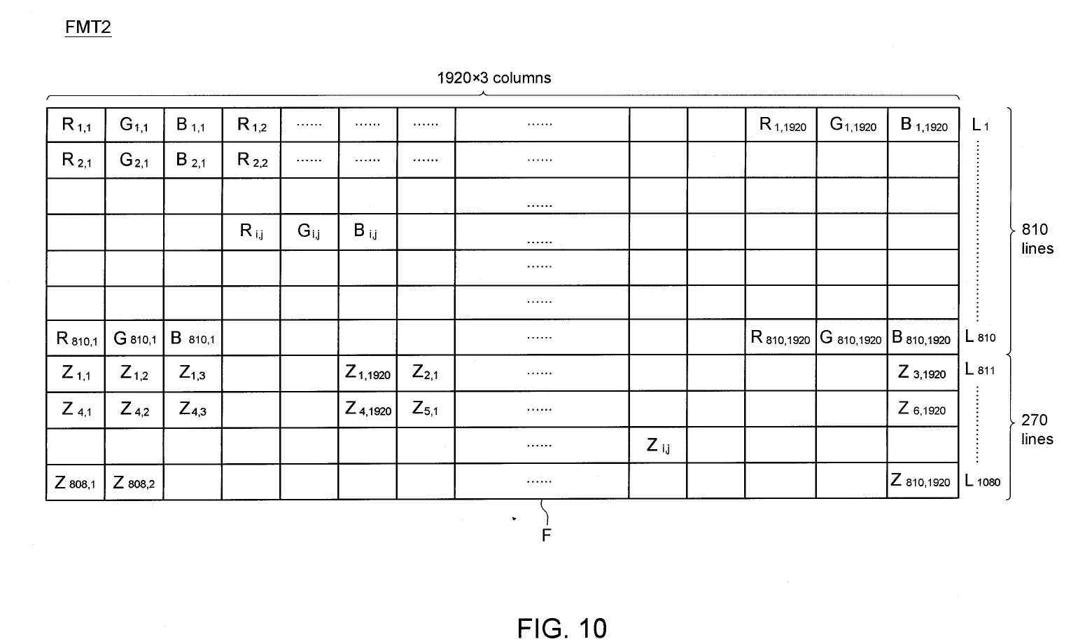

FIG. 10 is a schematic diagram illustrating the content of the data frame F assembled according to the format FMT2. In the portion of the 2D image frame M, G_{i,j} and B_{i,j} respectively represent the red, green and blue color data associated with each pixel (i,j)′, wherein each color data can be exemplary coded with 8 bits, the pixel line index i is in the range [1, 810], and the pixel column index j is in the range [1, 1920]. In the portion of the depth map Z′, Z_{i,j} represents the depth data associated with each pixel (i,j), wherein the depth data Z_{i,j} can be exemplary coded as a 8-bit grayscale value, the pixel line index i is in the range [1, 810], and the pixel column index j is in the range [1, 1920]. The data format FMT2 can encapsulate color data and depth data contiguously in the data frame F that at least has a number of lines and columns equal to those of the initial image frame M₀, i.e., 1920*3 columns by 1080 lines. In the data frame F according to the format FMT2, each of the lines L₁ to L₈₁₀ can include color pixel data, and each of the line L₈₁₁ to L₁₀₈₀ can include depth data taken from three orderly successive lines of the depth map Z′. For example, the line L₈₁₁ of the data frame F can include depth data from a first line of the depth map Z′ (e.g., Z_{1,1} through Z_{1,1920}), depth data from a second line of the depth map Z′ (e.g., Z_{2,1} through Z_{2,1920}), and depth data from a third line of the depth map Z′ (e.g., Z_{3,1} through Z_{3,1920}). In the same manner, the next line L₈₁₁ of the data frame can include depth data from the fourth to sixth line of the depth map Z′ (e.g., Z_{4,1} through Z_{6,1920}), and so on.

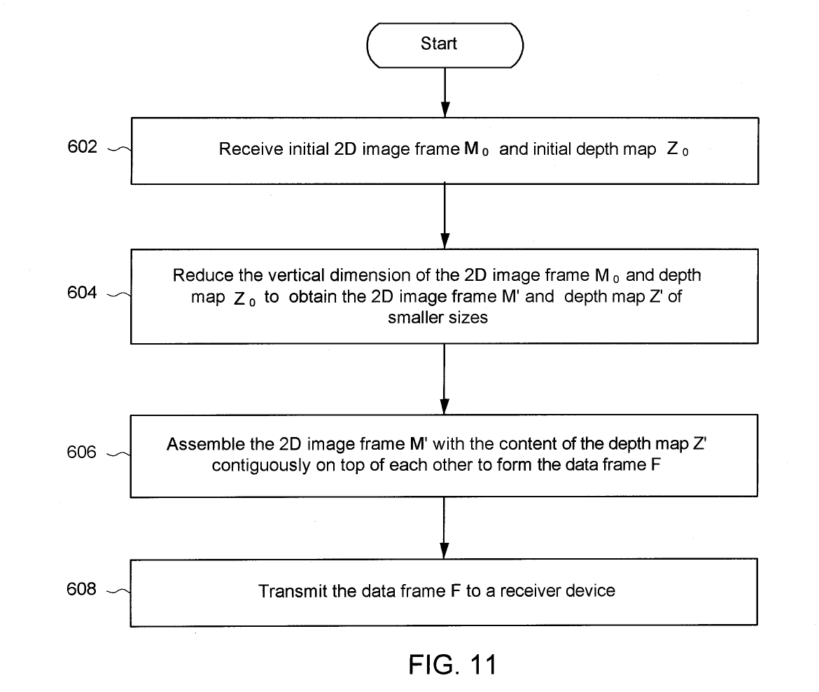

In conjunction with FIGS. 8 through 10, FIG. 11 is a flowchart of exemplary method steps performed in the transmitter device 102 for forming a data frame F according to the format FMT2. In step 602, the formatter unit 508 can receive an initial 2D image frame M₀, and an initial depth map Z₀. In step 604, the compression unit 532 can scale down the initial image frame M₀ and the depth map M₀ respectively into a 2D image frame M′ and a depth map Z′ of smaller sizes. For example, suppose that the initial image frame M₀ has a size of 1920*3 columns by 1080 lines, and the initial depth map Z₀ has a size of 1920 columns by 1080 lines. The compression unit 532 can reduce the vertical dimension of the initial image frame M₀ by 25% to obtain the image frame M′ of a size equal to 1920*3 columns by 810 lines, and reduce the vertical dimension of the initial depth map Z₀ to obtain the depth map Z′ of a size equal to 1920 columns by 810 lines. In step 606, the assembler unit 536 can construct the data frame F according to the format FMT2 by assembling the image frame M′ with the content of the depth map Z′ contiguously on top of each other as shown in FIG. 10. Accordingly, the data frame F formed according to the format FMT2 can have a number of lines equal to the number of lines in the initial image frame M₀, and a number of columns equal to the number of columns in the image frame M₀. In step 608, the data frame F then can be transmitted from the transmitter device 102 to the receiver device 104 via the link interface 106. As described previously, the data frame F can be entirely transmitted between two successive pulses of the vertical synchronization signal VSYNC.

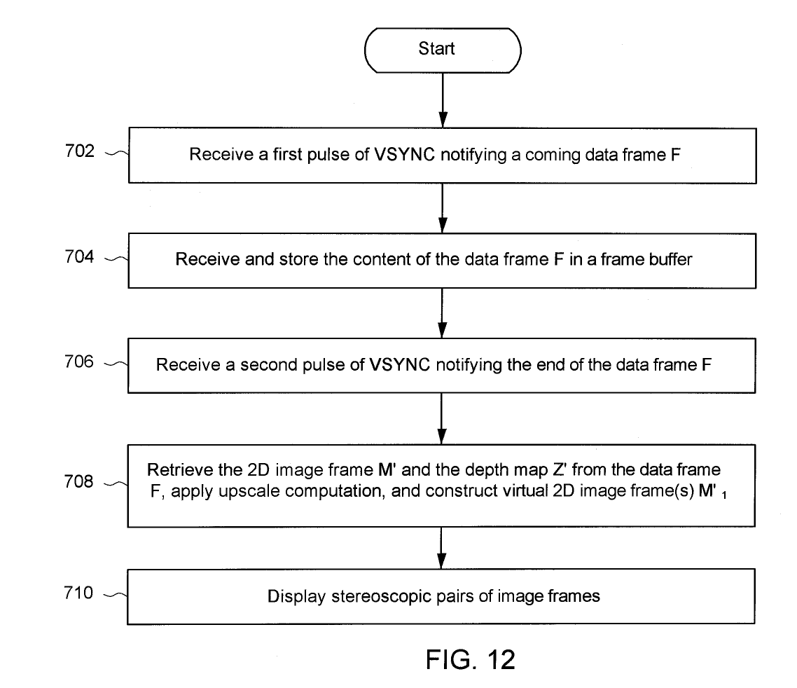

FIG. 12 is a flowchart of exemplary method steps for handling the data frame F formed according to the format FMT2 in the receiver device 104. In step 702, the receiver device 104 can be notified of a next data frame F from the transmitter device 102. As shown in FIG. 3, a first pulse of the vertical synchronization signal VSYNC can be received by the receiver device to indicate the coming data frame F. In step 704, the receiver device 104 can receive and store the content of the data frame F in the frame buffer 110. In one embodiment, the receiver device 104 can receive the frame F line-by-line in a sequential manner, and store each successive line into the frame buffer 110. Like previously illustrated in FIG. 3, the end of a previous line L(i) and the start of a next line L(i+1) in the data frame F can be detected via a high level of the horizontal synchronization signal HSYNC. In step 706, the receiver device 104 can be notified that all the content of the frame F has been received via a second pulse of the vertical synchronization signal VSYNC. An example of the data frame F stored in the frame buffer 110 can be as shown in FIG. 10. In step 708, the stereoscopic rendering unit 112 then can retrieve the 2D image frame M′ and the depth map Z′ from the frame F, apply upscale computation on the image frame M′ and the depth map Z′, and construct a virtual second 2D image frame M′₁ by using depth-image-based rendering (DIBR) techniques. In step 710, the up-scaled 2D image frame M′ and the virtual 2D image frame M′₁ can form a stereoscopic pair that can be displayed via the display unit 114.

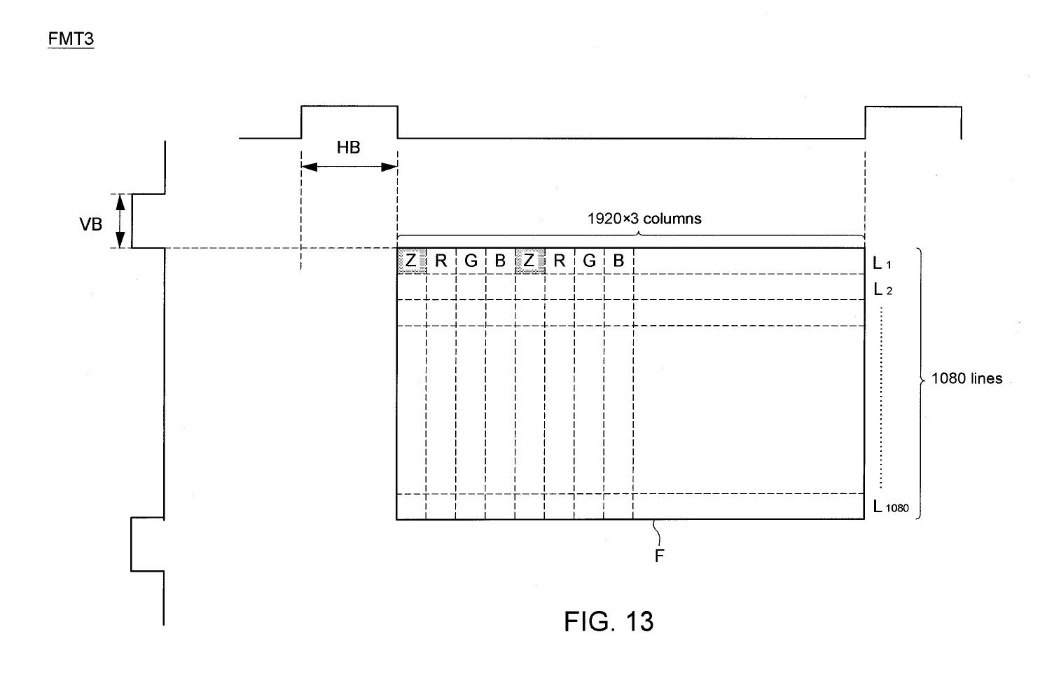

It is understood that other than the aforementioned examples, any arrangements that combine the down-scaled 2D image frame and the correspondingly down-scaled depth map in the data frame F may be applicable. FIG. 13 is a schematic diagram illustrating another example of the data frame F formed according to a format FMT3, in which the depth data Z of the down-scaled depth map and the triplet of the color pixel data R, G, B in the down-scaled 2D image frame can be distributed contiguously according to an alternated manner along each horizontal line of the data frame F. According to the format FMT3, the data frame F can have a size of 1920*3 columns by 1080 lines, which is the same size as the initial size of the 2D image frame before it is scaled down. The handling of the data frame F formed according to the format FMT3 at the transmitter and receiver devices can be similar to the methods described previously.

It is worth noting that while the aforementioned embodiments assemble the down-scaled 2D image frame and the depth map contiguously in the data frame F, alternate embodiments may also provide variant formats in which space regions can be inserted between the down-scaled image data and the down-scaled depth data to distinctly separate the region of image data from the region of depth data.

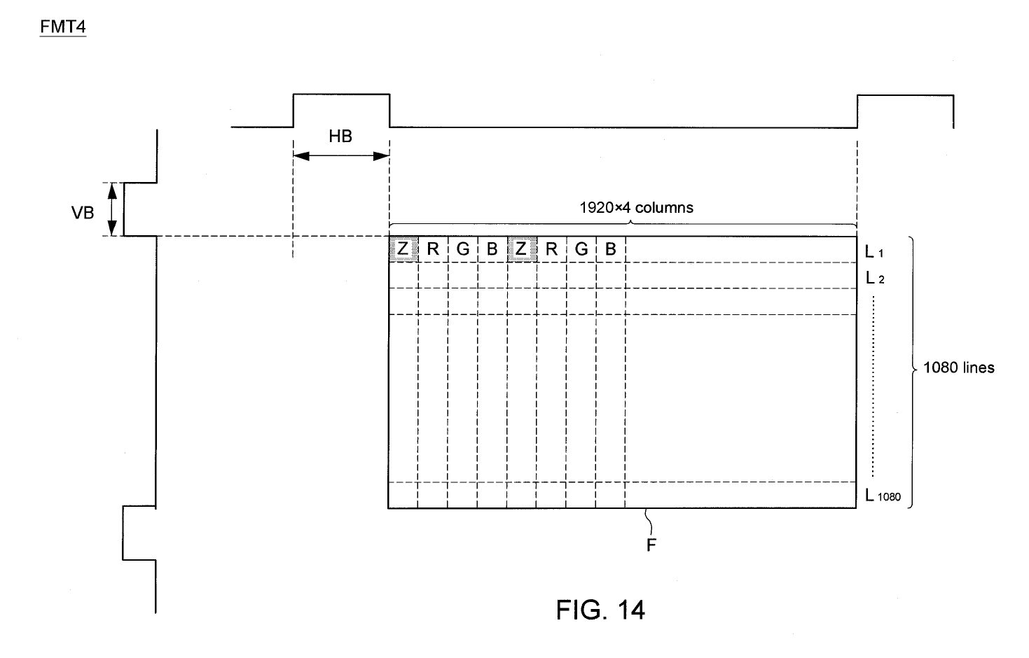

In each of the formats previously described, the 2D image frame and the depth map are down scaled before they are assembled contiguously in the data frame F. However, alternate embodiments may also assemble the 2D image frame with the depth map without the need of scaling down their respective size. As shown in FIG. 14, a data frame F formed according to another format FMT4 can have the depth data Z and the triplet of the color pixel data R, G, B distributed contiguously according to an alternated manner along each horizontal line of the data frame F. According to the format FMT4, the data frame F can have a size of 1920*4 columns by 1080 lines, which can be formed from the assembly of a 2D image frame having a size of 1920*3 columns by 1080 lines with a depth map having a size of 1920 columns by 1080 lines. The handling of the data frame F formed according to the format FMT4 at the transmitter and receiver devices can be similar to the methods described previously, except that no compression step is required at the transmitter device.

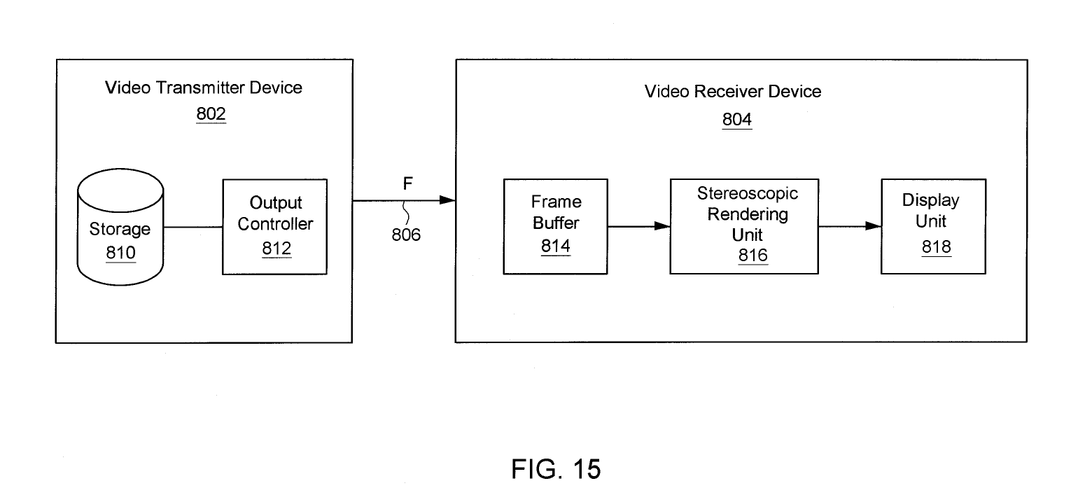

FIG. 15 is a schematic diagram illustrating another system embodiment for transmitting video content from a video transmitter device 802 to a video receiver device 804. The transmitter device 802 can operate to transmit a stream of data through a link interface 806 to the receiver device 804. The link interface 806 can be a HDMI link, Digital Visual Interface (DVI) link, or DisplayPort link. In one embodiment, the transmitter device 802 can include a storage device 810, and an output controller 812 connected with the storage device 810. The storage device 810 can include any computer-readable storage media. Illustrative computer-readable storage media can include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., hard-disk drive or any type of solid-state random-access semiconductor memory) on which alterable information is stored. The storage device 810 can store a plurality of data frames F formed according to any of the formats FMT1, FMT2, FMT3 and FMT4 described previously. The output controller 812 can be operable to access the storage device 810, and sequentially output the data frames F via the link interface 806.

The receiver device 804 can include a frame buffer 814 into which each received data frame F is stored, a stereoscopic rendering unit 816, and a display unit 818. The stereoscopic rendering unit 816 can retrieve the 2D image frame and depth map from the data frame F, apply computation to upscale the 2D image frame and depth map, and construct a virtual second 2D image frame based the up-scaled image frame and the depth map. The virtual second 2D image frame can have a size equal to the up-scaled image frame. The up-scaled 2D image frame and the virtual image frame can form a stereoscopic pair that can be presented on a display screen of the display unit 814.

At least one advantage of the systems and methods described herein is the ability to provide various frame formats that can assemble pixel color data of a 2D image frame and depth-rendering related data of a depth map into a data frame. Compared to conventional formats, the data frames described herein can be transmitted and stored in a more efficient manner.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the invention as defined in the claims that follow.

What is claimed is:

1. A method of handling a data frame in a video transmitter device, comprising:
receiving a two-dimensional image frame having a first number of lines and a first number of column;
receiving a depth map associated with the two-dimensional image frame, the depth map having a second number of lines and a second number of columns;
scaling down the two-dimensional image frame and the depth map to obtain a second two-dimensional image frame and a second depth map of smaller sizes;
assembling the second two-dimensional image frame with the second depth map into a data frame; and
transmitting the data frame from a video transmitter device to a video receiver device.

2. The method according to claim 1, wherein the data frame has a number of lines equal to the first number of lines of the two-dimensional image frame.

3. The method according to claim 1, wherein the data frame has a pixel size equal to 1080 lines by 1920*3 columns.

4. The method according to claim 1, wherein the step of scaling down the two-dimensional image frame and the depth map includes reducing the first number of columns of the two-dimensional image frame, and reducing the second number columns of the depth map.

5. The method according to claim 1, wherein the step of assembling the second two-dimensional image frame with the second depth map includes placing the content of the second two-dimensional image frame and the content of the second depth map contiguously side-by-side.

6. The method according to claim 1, wherein the step of assembling the second two-dimensional image frame with the second depth map includes placing the content of the second two-dimensional image frame and the content of the second depth map contiguously on top of each other.

7. The method according to claim 6, wherein the data frame includes a plurality of lines in which the content of the second depth map is placed, each of the plurality of lines include depth data taken from multiple successive lines in the second depth map.

8. The method according to claim 1, wherein the step of assembling the second two-dimensional image frame with the second depth map comprises:
placing color pixel data of the two-dimensional image frame and depth data of the depth map contiguously according to an alternated distribution along each line of the data frame.

9. A video transmitter device comprising:
a computer-readable medium containing a plurality of data frames, wherein each of the data frames includes image data of a two-dimensional image frame and depth data of a depth map, the image data being down scaled in size compared to a corresponding image frame presented on a display screen; and
an output controller adapted to access the computer-readable medium, and output the frames.

10. The transmitter device according to claim 9, wherein the two-dimensional image frame and the depth map are assembled contiguously side-by-side in each of the data frames.

11. The transmitter device according to claim 9, wherein the two-dimensional image frame and the second depth map are assembled contiguously on top of each other in each of the data frames.

12. The transmitter device according to claim 9, wherein color pixel data of the two-dimensional image frame and depth data of the depth map are placed contiguously according to an alternated distribution along each line in each of the data frames.

13. The transmitter device according to claim 9, wherein each of the frames is transmitted between two successive pulses of a vertical synchronization signal.

14. The transmitter device according to claim 9, wherein each of the data frames has a pixel size of 1080 lines by 1920*3 columns.

15. A video receiver device including a frame buffer, and a stereoscopic rendering unit coupled with the frame buffer, wherein the receiver device is configured to:
receive and store a data frame from a video transmitter device, the data frame including pixel color data of a two-dimensional image frame and depth data of a depth map;
retrieve the two-dimensional image frame and the depth map from the data frame stored in the frame buffer;
upscale the two-dimensional image frame and the depth map; and
construct a virtual two-dimensional image frame based on the up-scaled two-dimensional image frame and depth map.

16. The receiver device according to claim 15, being configured to receive the data frame between two successive pulses of a vertical synchronization signal.

17. The receiver device according to claim 15, wherein the two-dimensional image frame and the depth map are assembled contiguously side-by-side in the data frame stored in the frame buffer.

18. The receiver device according to claim 15, wherein the two-dimensional image frame and the second depth map are assembled contiguously on top of each other in the data frame stored in the frame buffer.

19. The receiver device according to claim 15, wherein the color pixel data of the two-dimensional image frame and the depth data of the depth map are placed contiguously according to an alternated distribution along each line of the data frame stored in the frame buffer.

20. The receiver device according to claim 15, wherein the data frame is transmitted to the receiver device via a link interface including one of high-definition multimedia interface (HDMI), digital visual interface (DVI), and DisplayPort.
